(19) United States
(12) Patent Application Publication
(10) Pub. No.: US 2016/0191449 A1
(43) Pub. Date: Jun. 30, 2016

(54) RANDOM CONTENT MESSAGING SYSTEM AND METHOD

(71) Applicant: Chatsee Inc., Seattle, WA (US)

(72) Inventor: Jacob RAPOPORT, Seattle, WA (US)

(21) Appl. No.: 14/811,516

(22) Filed: Jul. 28, 2015

Related U.S. Application Data
(60) Provisional application No. 62/029,901, filed on Jul. 28, 2014.

(51) Int. Cl. H04L 12/58; H04L 29/08

(52) U.S. Cl. CPC H04L 51/32; H04L 51/10; H04L 67/10; H04L 51/20

(57) ABSTRACT

A random content messaging system and method are provided. The system and method allows users to submit content to a service and the system makes that content available for discovery, viewing and interaction by other users as unorganized random selection of items. The submitted content, in the form of threaded conversations, is only discoverable by users of the system via that random request & selection mechanism.

### PRIORITY CLAIMS/RELATED APPLICATIONS

This applications claims the benefit under 35 USC 119(e) and priority under 35 USC 120 to U.S. Provisional Patent Application Ser. No. 62/029,901, filed on Jul. 28, 2014 and titled “Random Content Messaging System and Method”, the entirety of which is incorporated herein by reference.

### FIELD

A system and method whereby users submit content to a service, which then makes that content available for discovery, viewing & interaction by other users as unorganized random selection of items are disclosed.

### BACKGROUND

While social networking has seen an explosion of growth in recent years, the vast majority of the social networking products have focused on enabling one or more of three primary use cases: direct content between associated users, broadcast content among groups of associated users, or public dissemination of information. These social networking products have also traditionally employed various mechanisms to enable a user to establish, maintain and mange social connections with one another for the purposes of disseminating content within those channels.

Recently a number of products have also arisen that attempt to introduce aspects of anonymity to this process. These products generally provide the means whereby a user may submit content to such a network, while at the same time preserving the anonymity of the user who submits the content, other users, or both to varying degrees.

However, these aforementioned social networking products largely base their presentation of content around four key underlying principles:

1. Their content selection algorithms, by design, & by virtue of being driven by relatively static inputs, yield predictable & repeatable results.

2. The displayed content is organized chronologically.

3. The content is visible immediately upon download.

4. The selection of content presented is based on some form of established or implicit relationship between the users.

The existing systems also rely on some form of established association between users as a determinant factor with respect to the presentation of specific content. The mechanisms by which this association is determined can vary widely from the presence of identifying contact information in corresponding address books, to the more structured establishment of a “friend” relationship within the context of a given system. This includes instances where the users have no discernible or established connections between each other, and this fact primarily determines what, if any, content is presented.

Unlike the known systems described above, the disclosed system and method seek to overcome each one of the limitations of the known systems and present the user with a unique experience.

### BRIEF DESCRIPTION OF THE DRAWINGS

FIG. 1 is a diagram of an implementation of a random content messaging system;

FIGS. 2A and 2B are diagrams of the hardware stack and software stack, respectively, of the random content messaging system;

FIG. 3 illustrates a method for cleaning up expired content in the random content messaging system;

FIGS. 4A1-4A4 are examples of a new content user interface flow;

FIGS. 4B1-4B5 are examples of a random contact selection user interface flow;

FIG. 5 illustrates an example of a method for new content submission;

FIG. 6A illustrates an example of a method for getting random content;

FIG. 6B illustrates an example of a method for random selection of content;

FIG. 6C illustrates an example of a random content selection query method;

FIG. 6D illustrates an example of content validation method;

FIG. 6E illustrates an example of content expiration check method;

FIG. 6F illustrates an example of a modular content filtering method;

FIG. 7 illustrates an example of a random content query method;

FIG. 8A illustrates an example of a viewed filter method;

FIG. 8B illustrates an example of a blocked filter method;

FIG. 9 illustrates an example of an expiration method;

FIG. 10 illustrates an example of a random geographic point generation method; and

FIG. 11 illustrates an example of a database schema for the random content messaging system.

### DETAILED DESCRIPTION OF ONE OR MORE EMBODIMENTS

The disclosure is particularly applicable to the system and method that is implemented as described below. It will be appreciated, however, that the system and method has greater utility, such as to other implementations of the system and method that are within the scope of the disclosure.

The disclosure describes a system and method whereby users submit content to a service, which then makes that content available for discovery, viewing and interaction by other users as unorganized random selection of items. The submitted content, in the form of threaded conversations, is only discoverable by users of the system via that random request and selection mechanism. In the system, only the content a given user has not previously viewed, or authored, is eligible for inclusion in a request for a random selection of content by that user. In other words, once viewed, a specific content thread will not be included in future requests for a random selection by that user. Optionally, and by default, all users in the system are anonymized from both each other and the overall system itself.

Unlike existing systems, there is no organizational structure to the presented content in the system since the content is presented entirely as a random selection of objects without regards to any hierarchical, threaded, chronological, or other organizational system. So in addition to the content comprising the selection being chosen at random, the visual layout of the content when displayed is random. This might extend to either both the individual locations of the items onscreen as well as their relative position to each other or both.

When displayed as part of such a random selection, the content items might also not include any visual information, metadata, content, or queues or only include a limited subset of such data that would allow the user to discern the contents of the content prior to opening it. While some existing systems do hide the actual content of a message until the user “clicks through”, they do provide additional metadata (such as the identity of the author, or time sent) prior to this action. As opposed to those applications, this system may optionally extend the lack of visual indications or labels to include the specific identity of the author (anonymized or otherwise), timestamps, or any other identifying features.

The system, unlike the existing systems, relies on no such associative data or context, nor uses any such data or context as algorithmic inputs when generating its random selection. In this way, the statistical probability that a given results set contains content from parties known vs.

unknown to a user remain constant and entirely a function of the size and diversity of the content pool.

Optionally, in a manner similar to other ephemeral content systems, the primary messages are set to expire and be automatically purged from the system after a set period of time has elapsed from either the creation date of the message itself, or the date of it's last reply. In the current implementation of this system this option is enabled by default.

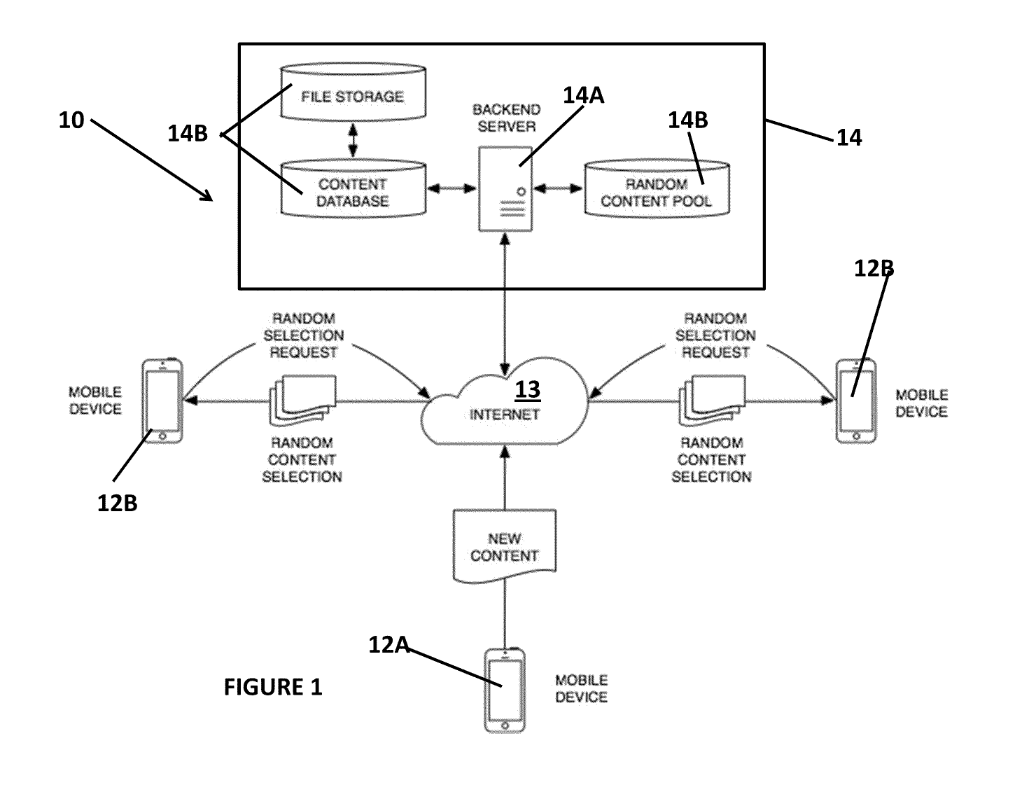

FIG. 1 is a diagram of an implementation of a random content messaging system 10. The system has two basic operations 1) uploading of new content using a first device 12A, and 2) retrieval of a random selection of content from the pool of previously uploaded content using other devices 12B, all via a mobile device connected to the service through an internet connection. Content is comprised of user generated photos, videos, & drawings with or without text & hashtags. The system may be implemented using one or more mobile devices 12 in which each mobile device may be a processor based device with memory and a display to interact with a random content backend 14. The mobile device may be, for example, an Apple iPhone, iPad, iTouch product, an Android operating system based device, a tablet computer, a cellular phone device and the like. Each mobile device 12 may have an application that is executed by a processor of the mobile device to interact with the backend 14. The application may be a browser application, a mobile application and the like. Each mobile device may connect to and interact with the random content backend 14 using known protocols and data transmission methods (that may be secure or not) over a wired or wireless communication system 13, such as the Internet as shown in FIG. 1 or a wireless data network, a computer network and the like. The random content backend 14 may further comprise one or more computing devices 14A, such as one or more server computers, one or more cloud computing resources, etc. and one or more data storage units 14B that may be either hardware implemented storage units or software implemented storage units. The storage units 14B may be coupled to the one or more computing devices 14A and may store a random content pool in which random content is stored and from which the random content is selected and sent to each mobile device 12B, a content database for storage of all of the content and other files/data used by the system.

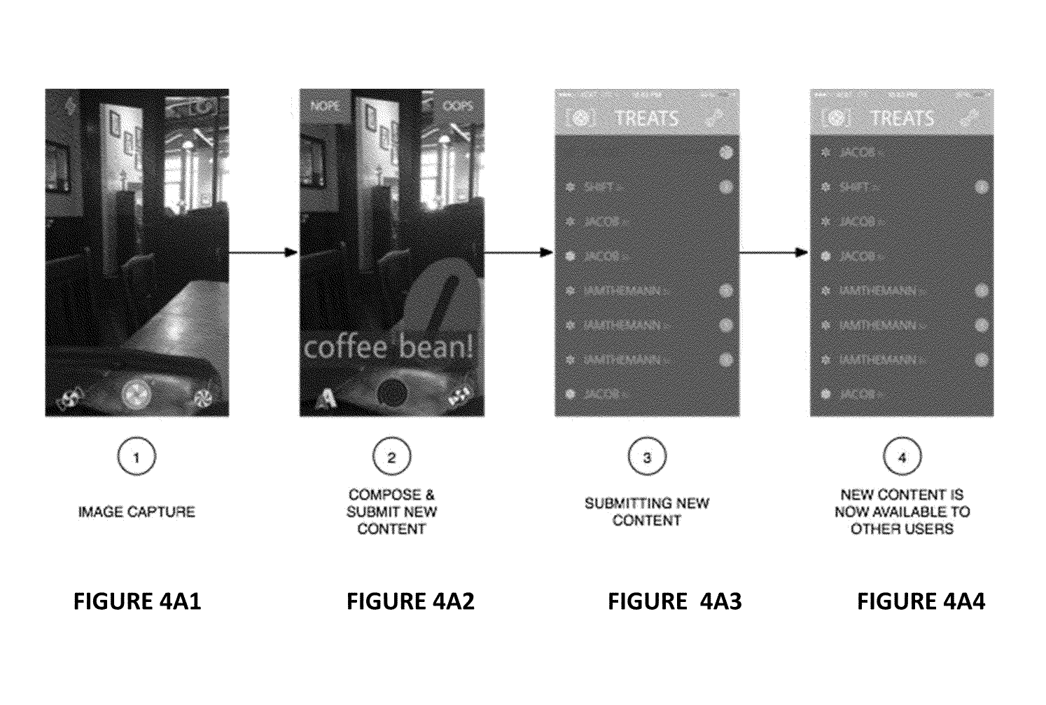

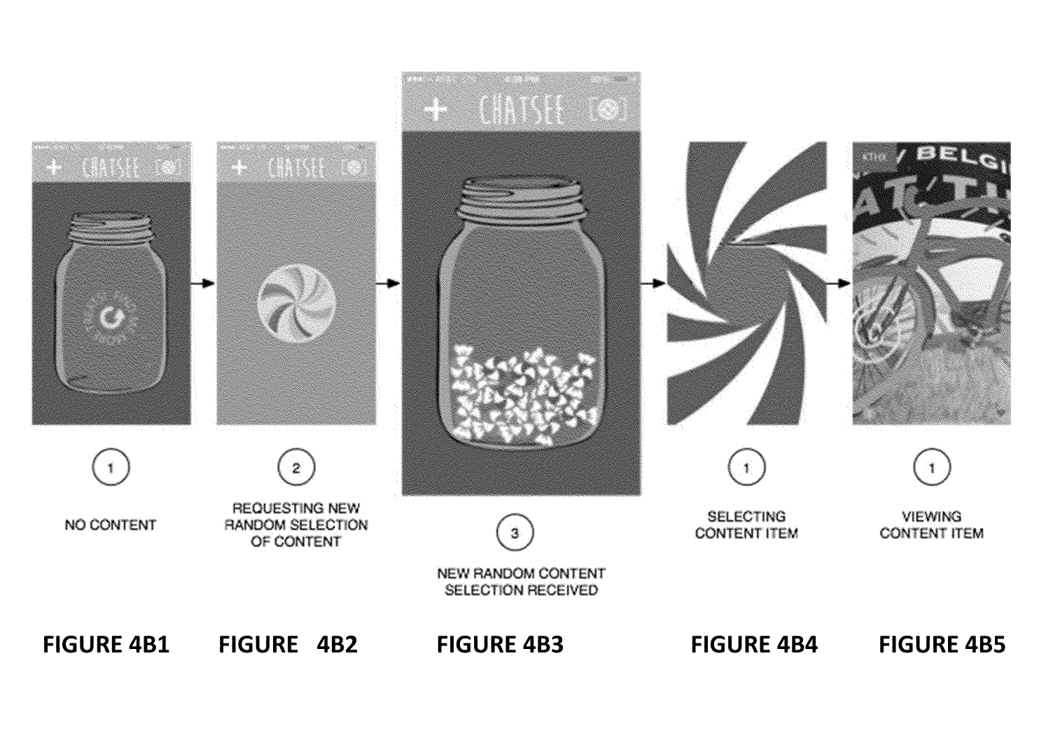

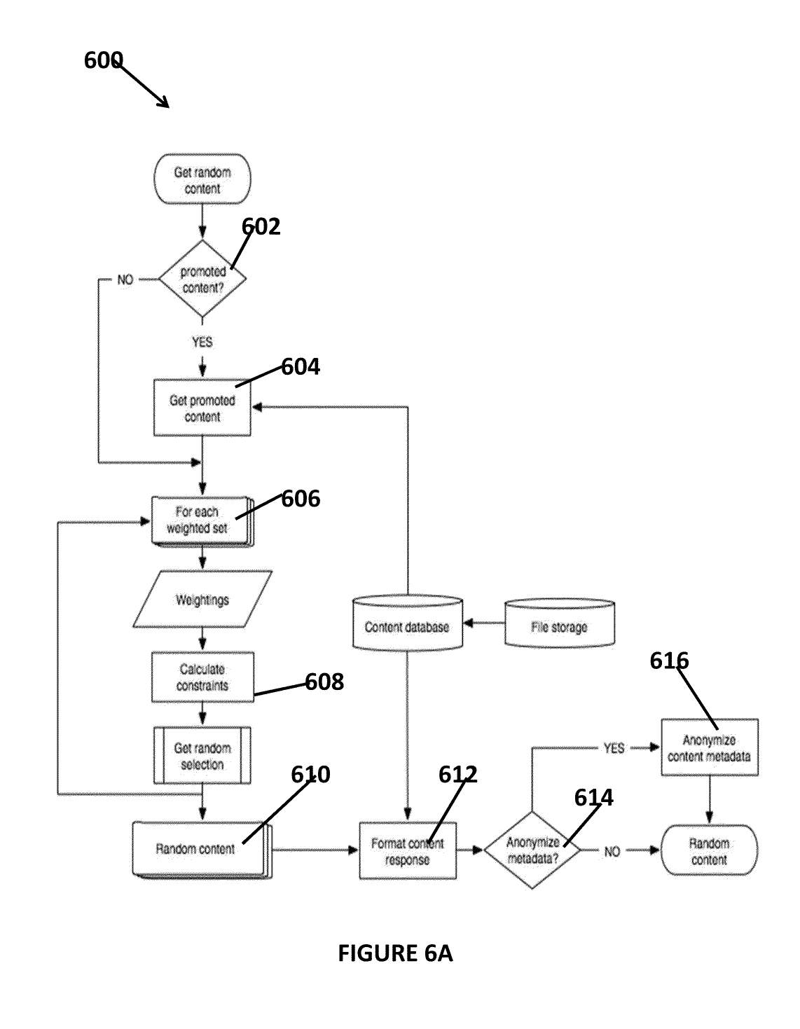

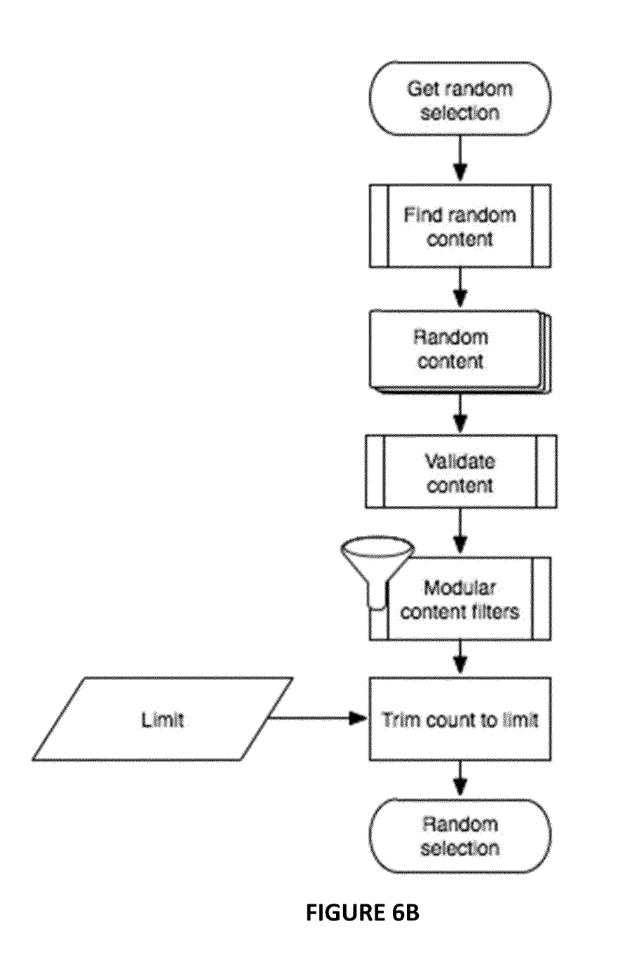

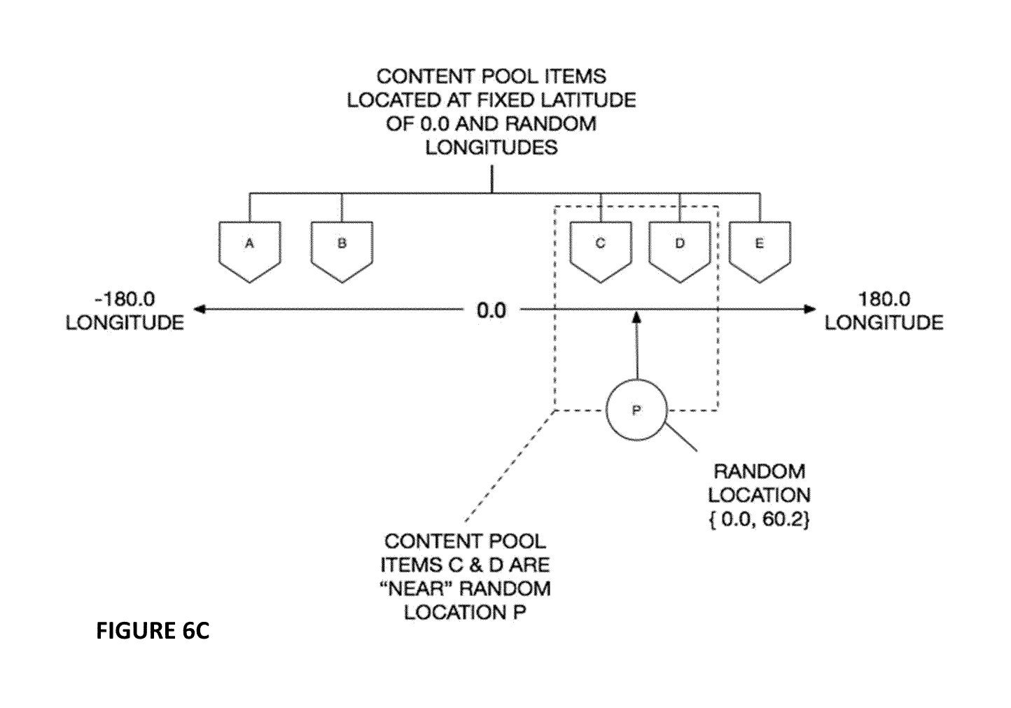

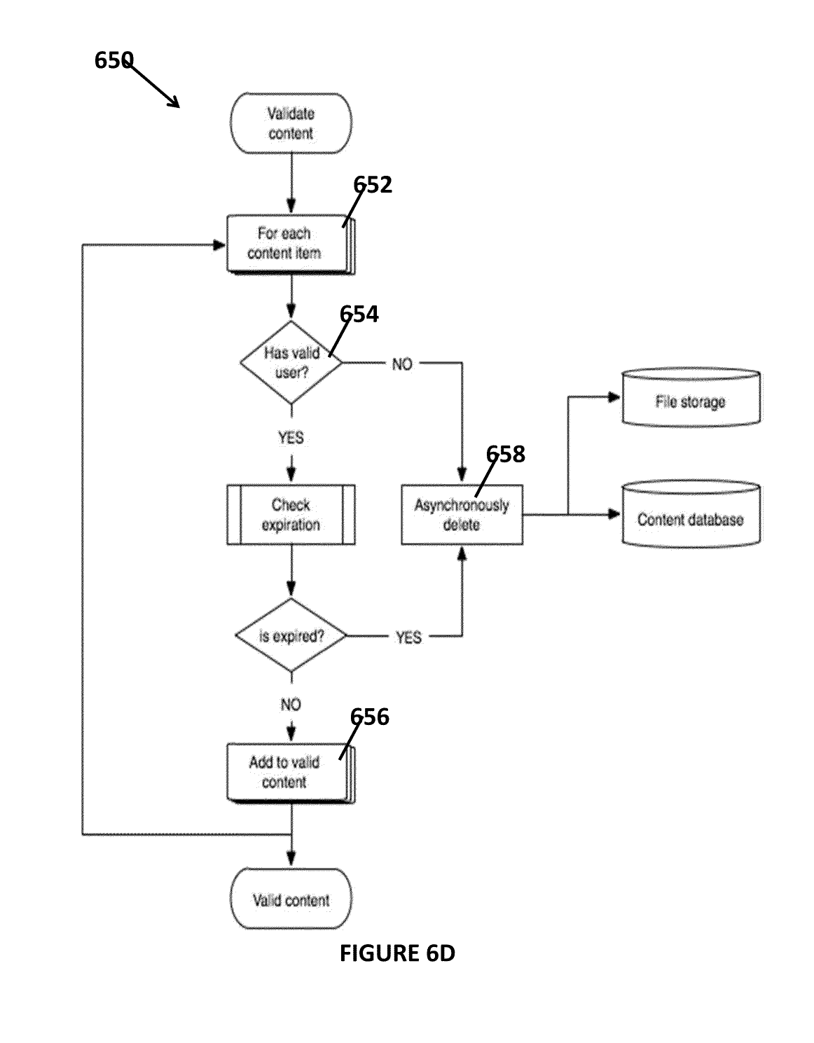

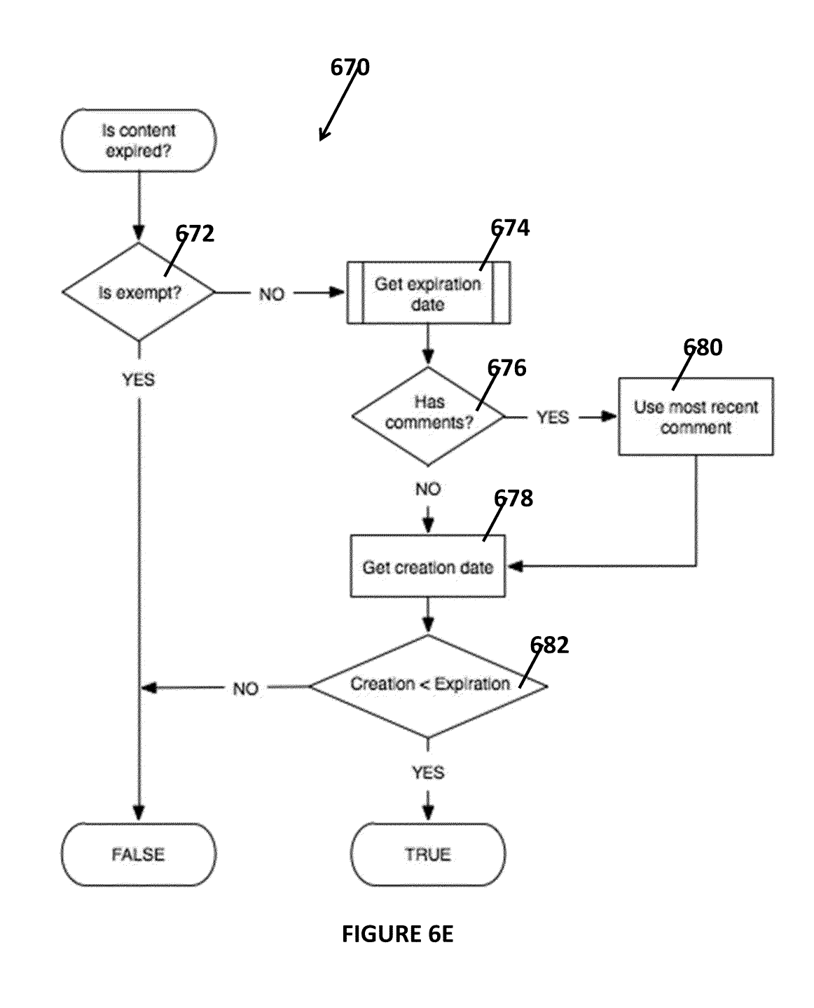

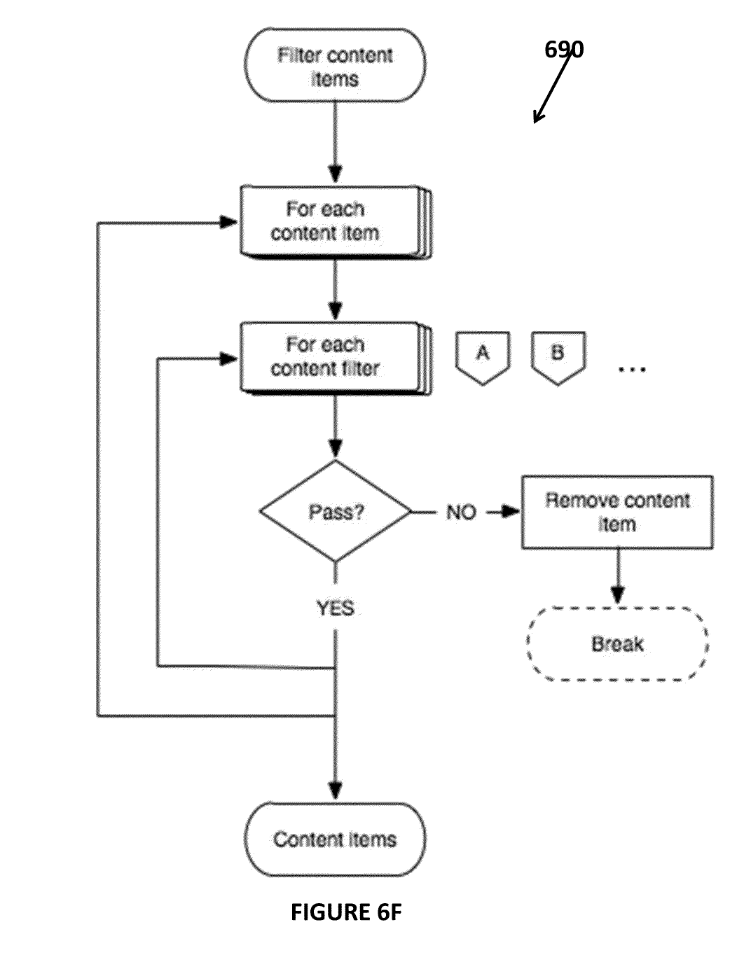

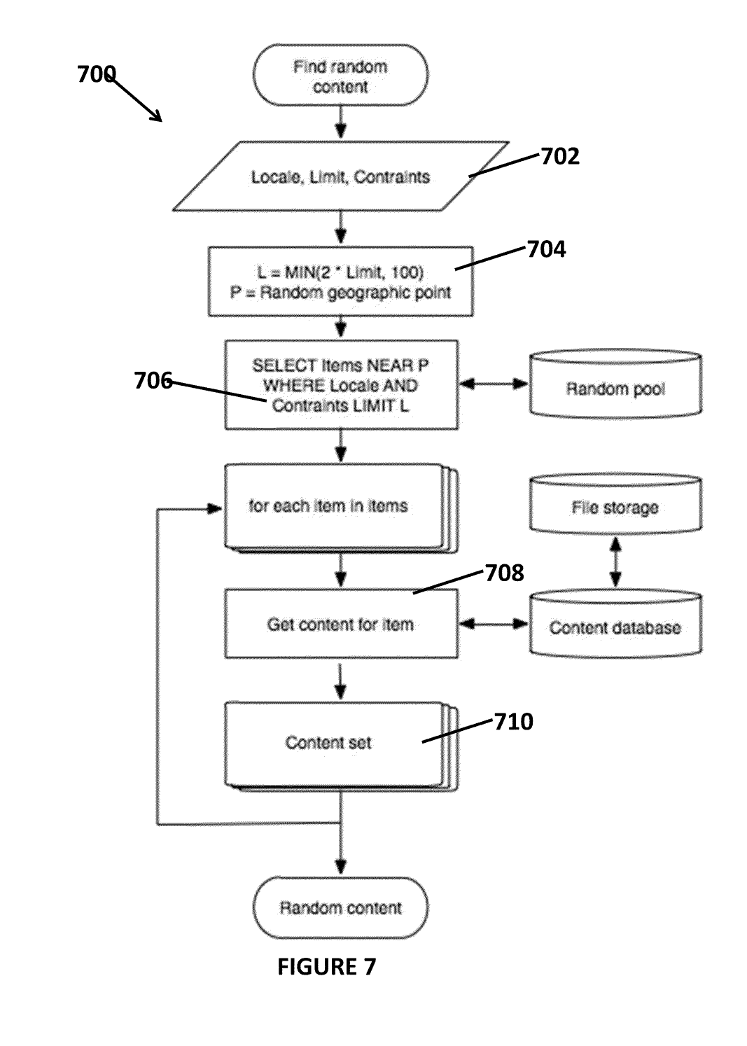

In operation, as shown in FIG. 1, a mobile device 12A may upload new content to the system. The details of the method for uploading new content is described below with reference to FIGS. 4A1-4A4 and 5. In addition, a mobile device 12B may request random content (and the random content is returned to the mobile device for display) and that process is described in more detail with reference to FIGS. 6A-7.

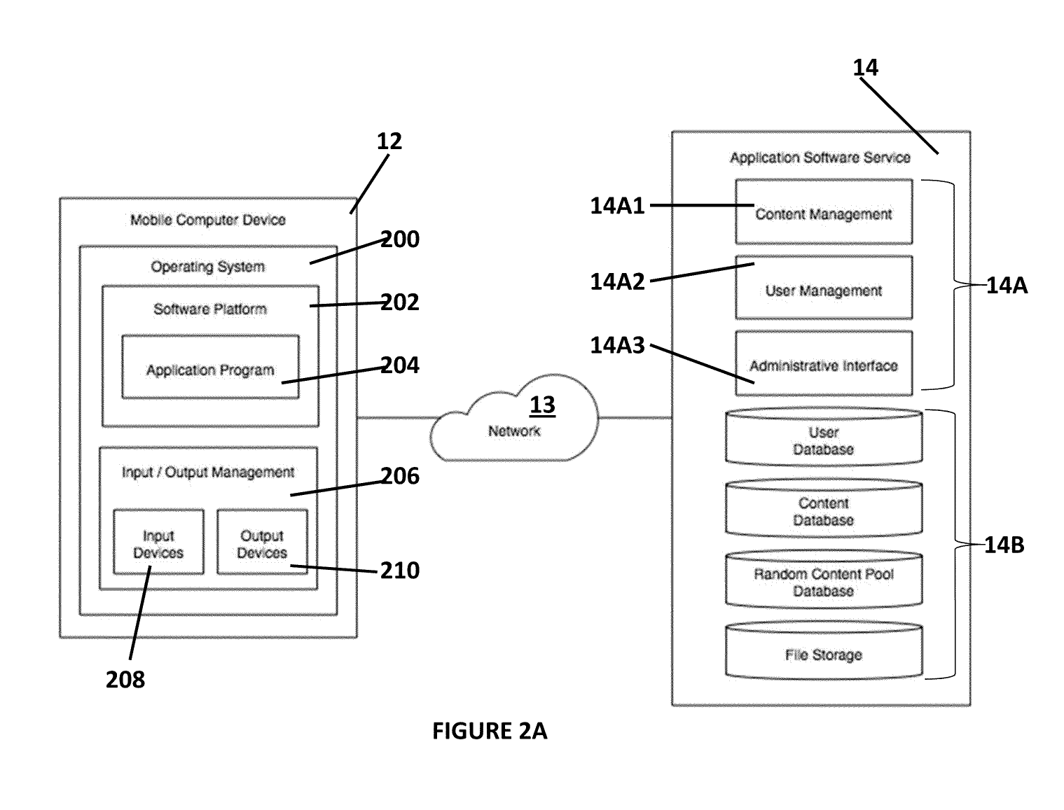

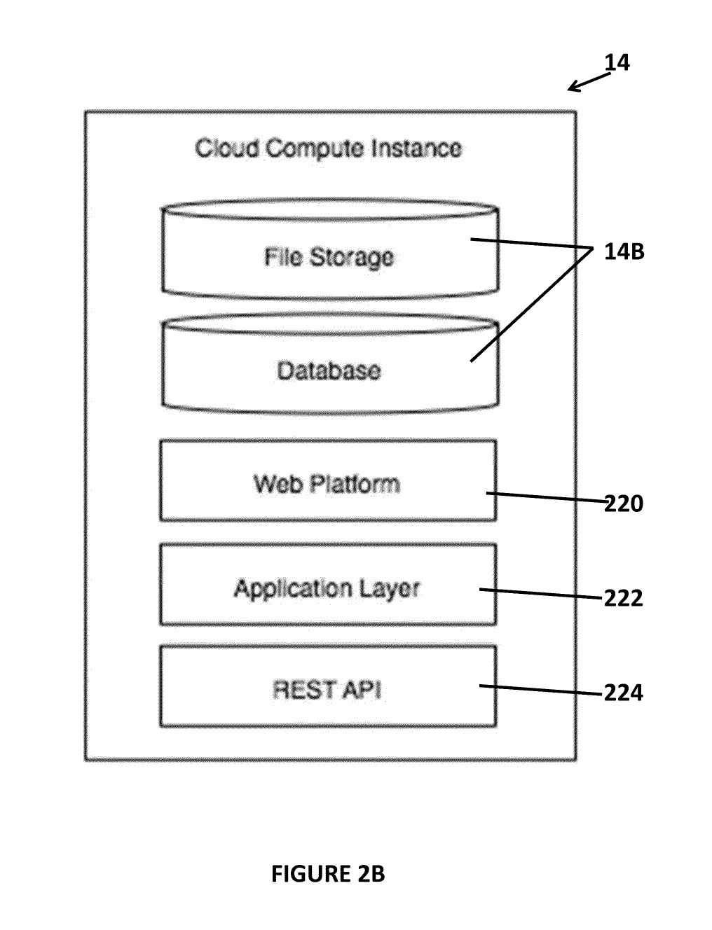

FIGS. 2A and 2B are diagrams of the hardware stack and software stack, respectively, of the random content messaging system 10. FIG. 2A illustrates the hardware stack of each mobile device 12 and the random content backend 14. Each mobile device 12 may be an OEM mobile computing device with an operating system 200, a software platform 202 and one or more required application programs 204 installed as shown. The application program uses the appropriate standard platform SDK in addition to other 3rd party SDKs and libraries as appropriate. The application program communicates with the service via a set of REST API. Each mobile device 12 may also have a input/output management component 206 that manages the one or more input devices 208 (such as a touchscreen or keypad) and one or more output devices 210 (such as a display) of the mobile device.

As shown in FIG. 2A, the random content backend 14 may have the elements shown in FIG. 2A including the storage devices 14B (including the various databases and file storage) and the one or more computing devices 14A that may further comprise a content management component 14A1, a user management component 14A2 and an administrative interface component 14A3. In one implementation, each of the elements of the random content backend 14 may be a plurality of lines of computer code that may be executed by a processor of the backend 14 computing devices to implement the random content messaging system as described below. The elements of the random content backend 14 may also be implemented in hardware circuits and devices.

FIG. 2B illustrates an example of the computing device of the backend 14 that may be one or more cloud compute instances running the application software of the service. The stack may include the one or more data storage devices 14B, a web platform 220 that manages the connections and communications with the mobile devices and an application layer 222 that may include the content management component 14A1, a user management component 14A2 and an administrative interface component 14A3 and may perform the methods described below in FIGS. 6A-10. The stack may also include a REST API framework for the application service interface 224 that manages the REST protocol communication between each mobile device and the backend 14.

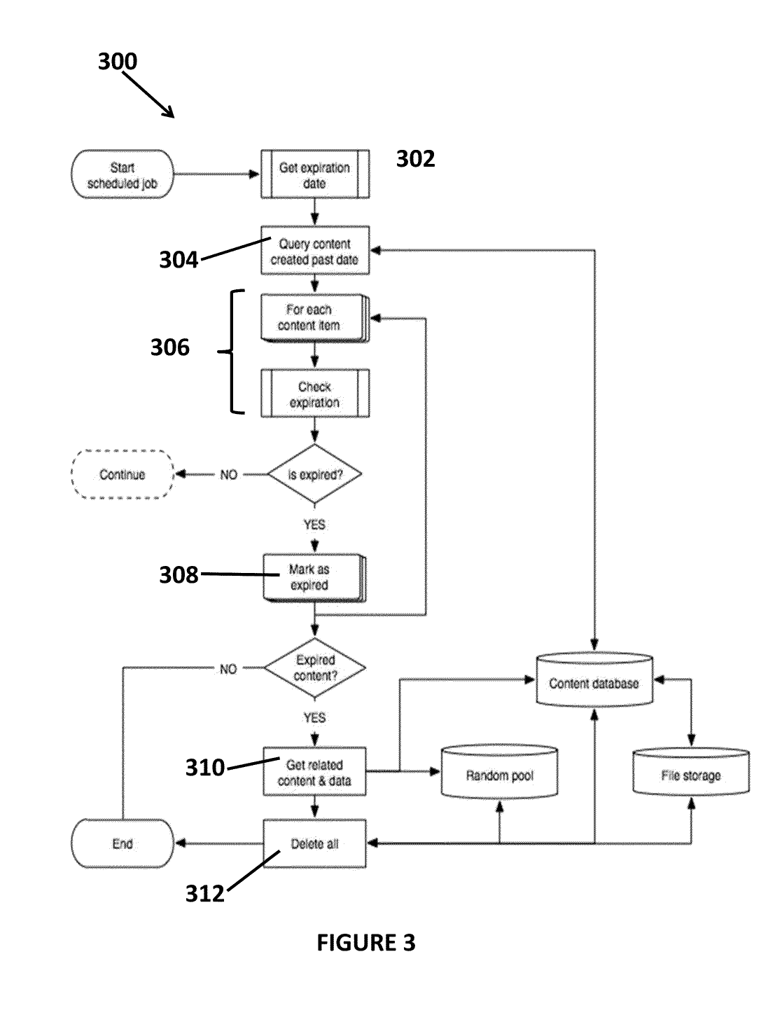

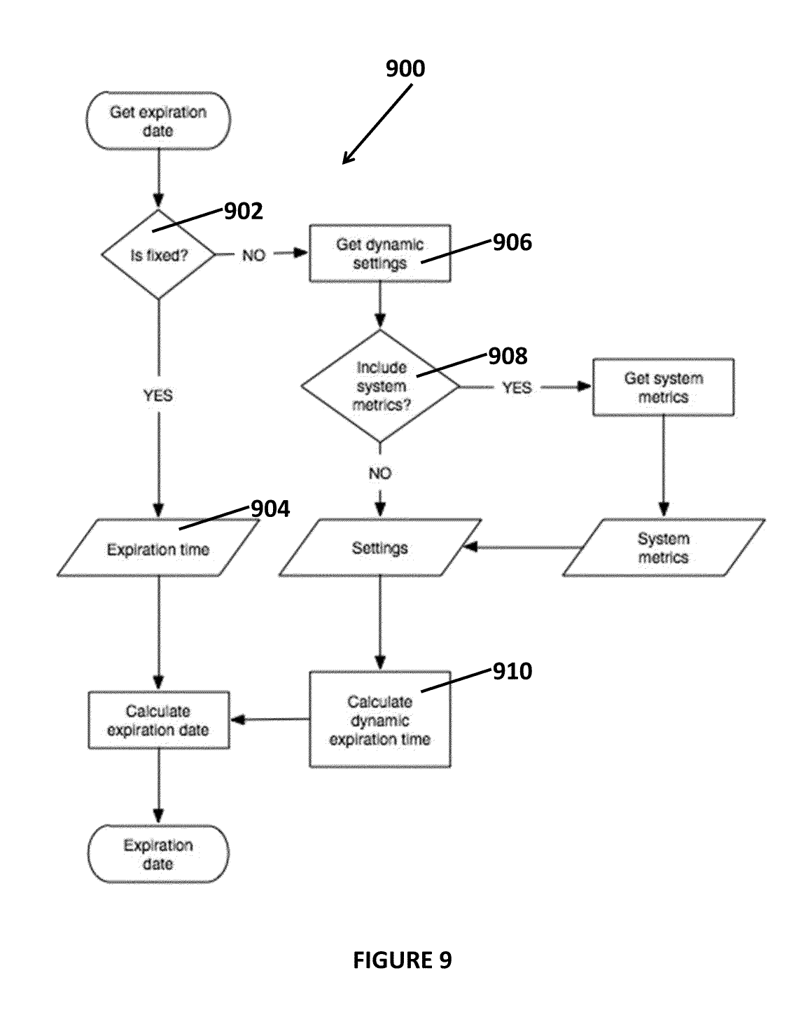

FIG. 3 illustrates a method 300 for cleaning up expired content in the random content messaging system. The method shown in FIG. 3 may be implemented by the random content backend 14 shown in FIG. 1 by the lines of computer code being executed by the processor. In other implementations, a processor of the backend 14 is configured to perform the processes shown in FIG. 3. During the method, on a set interval (currently 15 minutes, but can also be at other intervals), the backend runs a scheduled background job to scrub the system of expired content. During the process, the expiration date is first calculated (302) as shown in more detail in FIG. 9. Next the content database is queried for all content that was created past the expiration date (304). For each content item found, the system checks to see if the content is actually expired (306) as shown in FIG. 6e. If the content item is not expired, the method continues looping through the remaining items. If the content item is expired, the system adds the expired content to an array of expired items (308). After looping through all the items, the system may perform a check to see if any expired content items were actually found. If no expired items were found, the job/method ends. If expired items were found, the databases are queried for all the related or associated data to the content (files, comments, entry in the random pool, etc. . . ) (310). Once all the data is gathered, the content, along with all its related or associated data is deleted (312) from the system & corresponding databases.

FIGS. 4A1-4A4 are examples of a new content user interface flow that may be performed using the mobile device and the backend. In the system, only content created via this flow will be made available for random selection. First, to submit new content to the system, the user first pulls up the image capture screen of the mobile device. The user can take either a photo or a video comprised of N segments (totaling no more than 10 seconds, for example) of the content as shown in FIG. 4A1 using the input devices of the mobile device such as a camera. The time length of the photo or a video or the segments is not limited to the 10 seconds described above and different time lengths are within the scope of the disclosure. The user may also adjust the flash, switch cameras, apply filters and engage in other capture related activities and options.

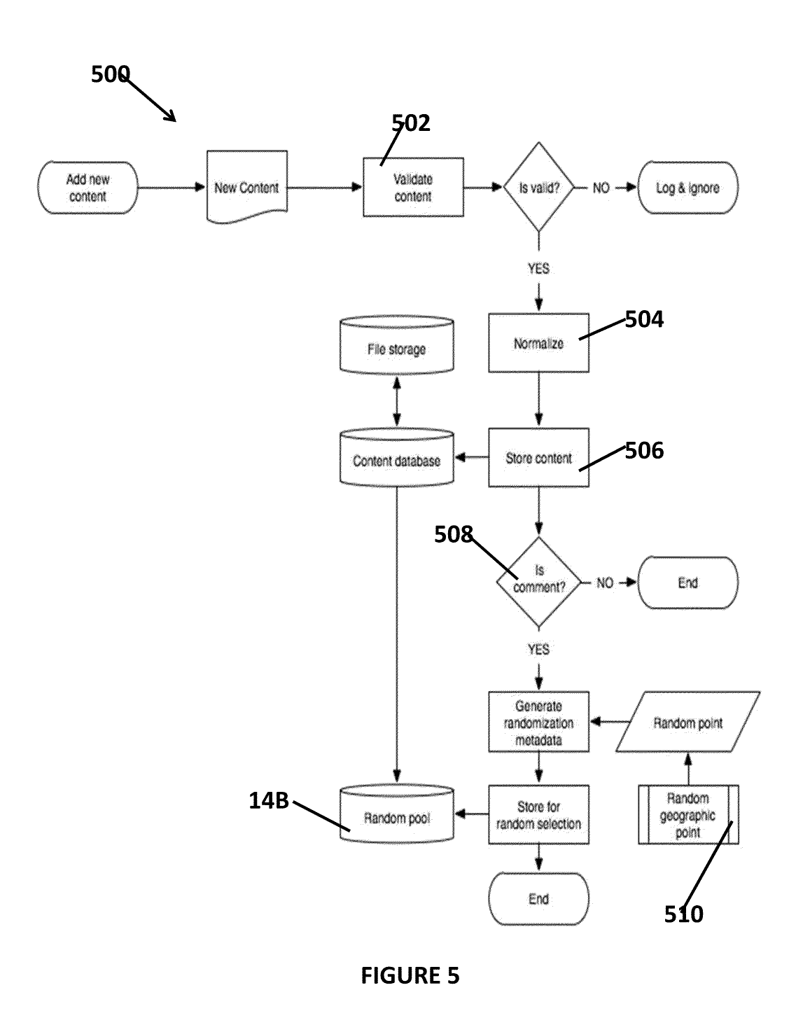

Once the user has captured a photo or video, a compose user interface screen shown in FIG. 4A2 may be presented to the user by the application running of the mobile device. Using this user interface, the user may edit the media in various ways including, but not limited to, adding text, drawings, applying additional filters, etc. Once the user has finished composing the content, the user may hit the SUBMIT button (lower right). Once the SUBMIT button is pressed the application will transmit the new content to the backend (shown in FIG. 4A3) and initiate the process detailed in FIG. 5 and take the user to their content screen. The new content is inserted at the top of the list and the spinning wheel denotes the pending outcome of the submission. Once the submission has been completed successfully, the list item becomes accessible (as shown in FIG. 4A4) and content is now available both for viewing by the user, and inclusion in a random selection of content by other users as detailed in FIG. 6a. If an error occurs, the application will continue to resubmit the content to the server at various intervals.

FIGS. 4B1-4B5 are examples of a random content selection user interface flow of the system. In the system, to view or request a new selection of random content, the user first navigates to the Candy Jar screen as shown in FIG. 4B1. For the purposes of illustration, the jar in this screenshot is empty. If there is no content present, the REFRESH button will be visible. If there is content present in the candy jar, shaking the device will remove all existing content, and request a new selection. If there is content present in the jar, tapping the CHATSEE header will request additional random content to be added to the jar. Taking one of those actions will cause the user interface shown in FIG. 4B2 to display and initiate a new asynchronous REST request for random content as outlined in FIG. 6a. While the content request is in progress this screen and it's animated progress spinner will be displayed as shown in FIG. 4B2.

Once the request returns, if the response contained no content items, the REFESH button will be displayed as depicted in FIG. 4B 1. If there is content to be added, once the additional data required to display the message has been downloaded, the content will be added to the jar in the form of a colored candy as shown in FIG. 4B3. The maximum number of candies the jar can contain, and by virtue the content selection size, is currently limited to a total of 30 items, but the system may use a different maximum number of candies which is within the scope of the disclosure. FIG. 4B4 illustrates an example of a user interface on the mobile device 12 (such as a user interface of the application of the mobile device) through which a user of the mobile device 12 may select a piece of random content. FIG. 4B5 illustrates an example of a user interface on the mobile device 12 (such as a user interface of the application of the mobile device) through which the random content may be displayed on the mobile device 12.

FIG. 5 illustrates an example of a method 500 for new content submission. Upon submission to the API, new content is first checked for validity (502) & basic integrity (not depicted). This check consists of a series of basic checks to ensure the content is valid and able to be entered in the system. These checks include the presence of a valid user object for the author, valid image or video files, valid parent item (if set), and other basic data integrity checks.

If the content is not valid, the result is logged and the method exits. If the content is valid, the data is first normalized (to whatever extent is necessary) (504). This may include things like the extraction of hashtags from text for the purposes of indexing, the setting of default metadata values, etc. Once the content is normalized it is committed (506) to the content database along with its meta data and relevant file storage pointers. The actual image or video file data is uploaded in an orthogonal, asynchronous process. If the content being uploaded has a pointer to another previously uploaded content item set as its parent item (508) (and therefore is a comment or reply), the request is complete and exists successfully.

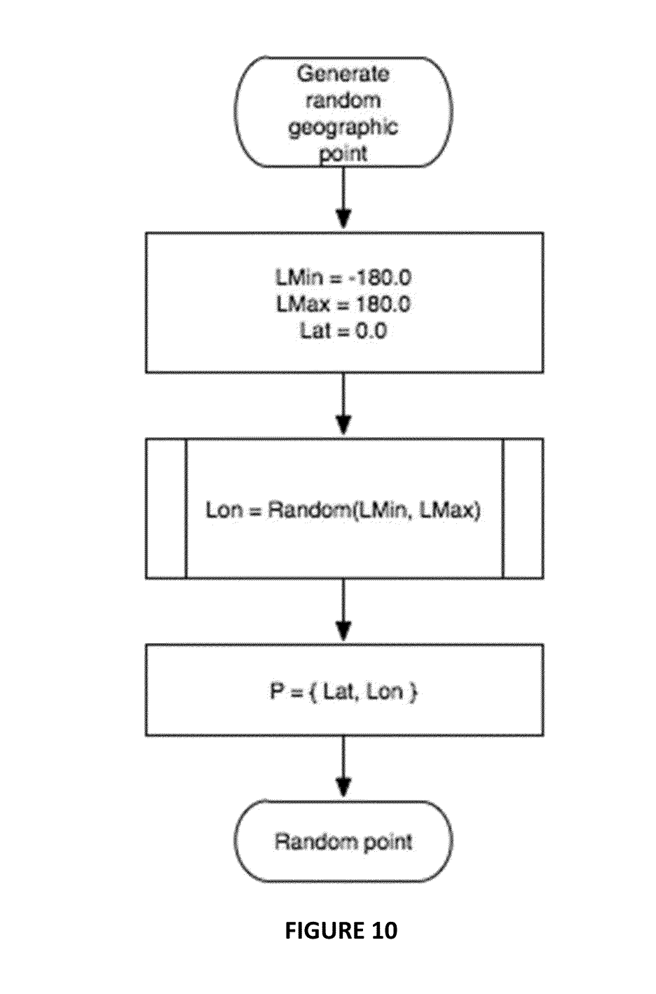

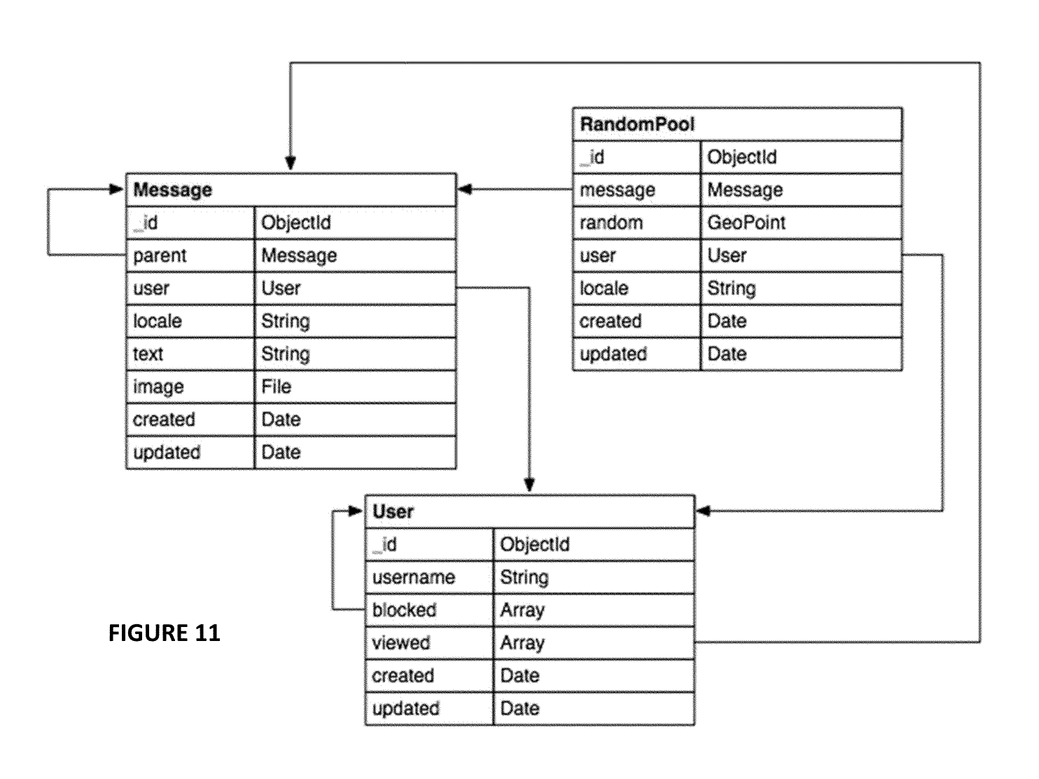

If the content being upload does not have a parent item, and therefore is not a comment, it will be added to the random content pool 14B. To do this a new entry for the pool database is generated. A random geographic point 510 for the entry may be generated (FIG. 10), and set as the randomization key. This key is required in order to later retrieve the content as part of a random selection as described in FIG. 7. The entry will also include a pointer to the actual content, along with some additional metadata to facilitate indexing and retrieval. Once this is done, the entry is saved to the Random Pool database (FIG. 11) and the request completes successfully.

Each of the processes shown in FIGS. 6A-6F may be performed by the backend 14 and more specifically the content management component 14A1 of the backend 14. In one embodiment, a processor of the backend 14 may execute a plurality of lines of computer code of the content management component to implement the processes described. In other embodiments, the content management component may be a piece of hardware (circuit, FPGA, etc) that implements the processes.

FIG. 6A illustrates an example of a method 600 for getting random content. Once the backend receives a request for a selection of random content, there is first a check to see if any optionally promoted content for the user is available (602). Unlike other content, content marked as promoted would be guaranteed to be included in any request for a content selection. While not random, this mechanism could be used to deliver special or priority system messages or content to the user that might otherwise not be guaranteed to be included, e.g. A special happy birthday message. If such promoted content exists, it's retrieved from the content database (604) using the appropriate queries for inclusion in the overall content response. Once this is complete, the system then sequentially executes a query using each of the relevant content selection weightings in turn (606). Each weighting contains a series of rules that are then calculated into parameters and query constraints (608) for the actual content query process (FIG. 7). For example, it may contain a series of query constraints restricting the results only to content which have more than 10 children associated with them (i.e. more than 10 comments), or content which has been viewed by more than N number of users, or both, etc.

Each of these sets also has an associated percentage. This percentage is a decimal number (0.0-1.0), which determines a best effort that the percentage of the total response will comprise. e.g. A percentage may have a value of 0.5, or 50%, meaning 50% of the total content retrieved should be drawn from this set. To do this, the value is translated in to a limit based on the size of the selection requested minus any promoted content. So using the previous example, the request is for 30 items, and there are 10 items of promoted content, the limit passed to the query process (FIG. 7) for a set with a 50% weighting would be: ((total request size−promoted count)*weighting), or

((30−10)*0.5), or 10.

Once the constraints for the weighting have been calculated the process for a random selection is executed (FIG. 6b) and the results collected (610).

Once all the selection queries have been executed, the results are formatted (612) for response. This is comprised of two actions. The first takes the content retrieved from the selection requests, applies the percentages of their corresponding weightings, and stores the results in a set (to prevent duplicates). A best effort is made to preserve the requested weightings, however a rebalancing may occur if one of the weightings returned fewer items than requested in order to maintain the total requested selection size.

With the content set is complete, the relevant databases are queried for any related data, or metadata that needs to be returned with the response (e.g. the comment thread). This data is merged with the content to produce the final response object.

Finally a check is made to see if the response should be further anonymized (614) and the returned objects stripped (616) of any identifying data, internal or external, such as internal user object database ids. This is ON by default. Once completed, the response is returned and the method exits returning the random selection of content.

FIG. 6B illustrates an example of a method for random selection of content. This method first fetches a random set of content based on the calculated constraints provided by the weighting described in FIG. 6A. As described in detail by FIG. 7, and illustrated by the example in

FIG. 6c, the randomness is achieved by requesting items from the pool NEAR the randomly generated point. After executing that method, the resulting set of random content is then validated (FIG. 6d), with any invalid content being removed. Having removed the invalid content (if any), the content set is then run through a modular set of content filters (FIG. 6f) to remove any unsuitable items that cannot be handled as constraints when fetching the content initially (FIG. 7.) Once filtered the size of resulting content set is trimmed to the supplied limit if necessary and returned.

FIG. 6D illustrates an example of content validation method 650. For each content item in a set, this process first checks to see if the user (content author) is still valid (652). It is possible that while a user was removed from the system for whatever reason, all of their associated content was not. This check assures that any such orphaned content is not returned in the request. If the user (content author) is still valid, the method then checks to see if the content is expired (detailed in FIG. 6e) (654). If the user is valid, and the content is not expired the item is added to the set of content items (656) to be returned as valid. If the either the user is invalid, or the content is expired, the content item (and all its related or associated data—comments, random pool item if applicable, etc,) is asynchronously deleted (658) from the system. Once all items have been validated the process exits.

FIG. 6E illustrates an example of content expiration check method 670. This method checks content to determine whether or not it has actually expired. First there is a check to see if this content is exempt from expiration (672). This flag might be set if, for example, the content is actually a system-wide notification. By default this flag is set to FALSE. If this flag is set to TRUE, the function immediately exits and returns that the content has not expired.

If this flag is set to FALSE, the function continues and retrieves the current expiration date (FIG. 9) to use (674). Next the method checks to see whether or not the content has any additional activity that would influence the expiration. In one embodiment, this check may be limited as to whether or not the content has any children (i.e. comments) associated with it (676). If the content does not have any children, the creation date of the content is used (678). If the content does have children, the creation date of the most recent child is used (680).

The method then compares the creation date to the expiration date (682). If the creation date is earlier than the expiration date, the content is expired and the function returns TRUE. If the creation date is later than the expiration date, the content is not expired and the function returns FALSE. Currently, this check is not performed on content that has a parent (i.e. is a comment).

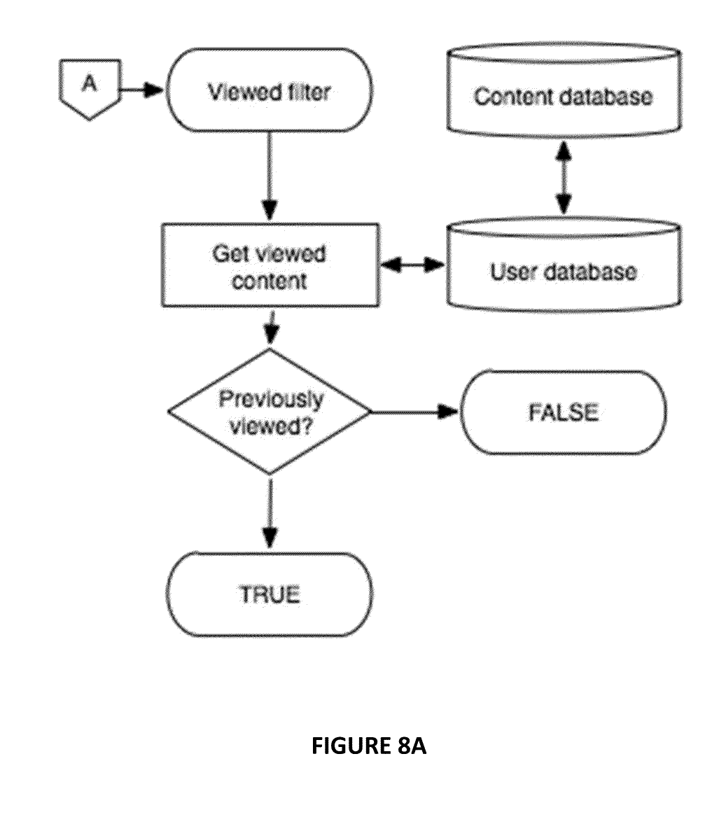

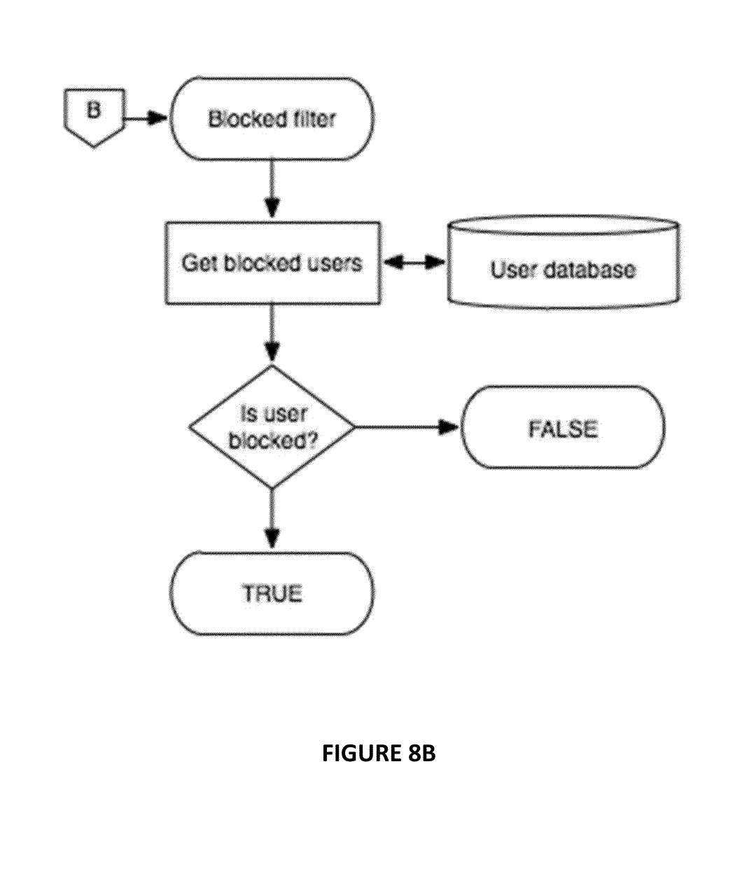

FIG. 6F illustrates an example of a modular content filtering method 690. For each content item in a set this process tests to see that the content passes each of the enabled content filter modules. Although the filters are modular & configurable, two filters are required and always executed before any remaining filters. The first filter checks to see whether or not the requesting user has previously viewed the content (FIG. 8a). This check is critical as the user should never receive content they have previously viewed as part of any request for a random selection.

If the content has not been previously viewed, the process proceeds to the second required filter. This filter checks to see if the content author has been blocked by the requesting user (FIG. 8b). If the content author has not been blocked, the process proceeds to the next filter in the chain. If a content item fails to pass a filter test, subsequent tests are skipped, the content is removed from the list of content items to be returned, and the process proceeds to the next content item. Once all the content items have been checked, the items passing all filters are returned.

FIG. 7 illustrates an example of a random content query method 700. This method takes two required parameters (702) as constraints: locale, & size limit, along with N of variable ones (currently NULL). The locale restricts the language of the content as determined by the primary locale set on the mobile device and recorded when the content was submitted. The limit indicates a desired size of the resulting content set. First, the requested limit is doubled, and restricted to a maximum. And a random geographic point is generated (FIG. 10) (704). In the current implementation, this maximum limit is set to 100 items (based on the current maximum imposed by the mobile of 30 items), but the maximum limit may be set to other values. Due to the nature of the system, the exact size of the resulting set cannot be known at this time.

This is compounded by the inefficiency in trying to determine certain key characteristics of this content as a query constraints, such as whether to not the content has been previously viewed by the user. This is due in part to several limitations of the underlying database system employed in the current implementation. This may not be true in future implementations and thereby provide a more optimal way to determine the final size of the result set prior to execution. By doubling the limit, the method may insure that even after removing potentially invalid content and subsequent filtering the resulting content set will contain at least as many items as indicated by the limit.

As illustrated in FIG. 5, the location of the items in the pool was assigned a random geographic point (random longitude as shown in FIG. 6C) when added. By querying the content pool for items NEAR the newly generated random geographic point (706). The method receives a set of random content items (FIG. 6c). The method then takes each of the randomly selected items returned from the pool and fetches the actual content for the associated items (708). As it is returned, this fetched content is collected into a set (710). Once all the content has been collected the content set is returned and the method exits.

FIG. 9 illustrates an example of an expiration method 900. This function retrieves the current expiration date for use in determining expired content. First the function checks a global flag to see whether or not a fixed expiration date (902) is being used, currently set to TRUE by default. If TRUE, the function uses the global expiration time setting (in seconds) (904). If FALSE, the function then retrieves the global settings for content expiration. These settings comprise a set of parameters that may be used to calculate a dynamic expiration time (in seconds) (906). An example of which might be a schedule used to calculate an expiration time which varies with the time of day. Or a particular set of users' content may have an expiration time that differs from other users in duration.

The function then checks to see whether or not system metrics (908) should be included when calculating the expiration time. If they should be included, the function retrieves the relevant system metrics to be used. These may include such things as the overall system load, number of requests per second, total number of content messages, etc. The function then uses these settings to calculate a dynamic expiration time (in seconds) (910). The function then subtracts the expiration time from the current date and returns the calculated date as the expiration date.

FIG. 10 illustrates an example of a random geographic point generation method. When generating a random geographic point for use with the content pool random selection mechanisms the latitude is fixed to 0.0. A random number for the longitude ranging from −180.0 to 180.0 (inclusive) is then generated. The resulted point ensured that all content will be “located” somewhere along the longitudinal spectrum at latitude 0.

FIG. 11 illustrates an example of a database schema for the random content messaging system. As shown, the database may include a message object, a random pool object and a user object as shown.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers,. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.)

and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A system, comprising:
a random content system having a random content pool, the random content pool containing a plurality of pieces of content, wherein each piece of content is randomly stored in the random content pool;
one or more mobile devices, each mobile device capable of being coupled to the random content system and one of uploading a new piece of content to the random content system and requesting one or more pieces of random content from the random content system; and
the random content system receiving a request for random content and providing, to a mobile device, a random selection of content from the random content pool in response to the request for random content wherein the random selection of the content is limited by a content filter that does not permit the mobile device to receive a piece of random content already displayed on the mobile device.

2. The system of claim 1, wherein the random content system selects a promoted piece of random content to select a special piece of content.

3. The system of claim 1, wherein the random content system selects one or more pieces of random content from the random content pool.

4. The system of claim 3, wherein the random content system selects the one or more pieces of random content based on a weighting of each piece of random content.

5. The system of claim 3, wherein the random content system determines a random location in the random content pool and selects one or more pieces of random content within a proximity of the random location.

6. The system of claim 5, wherein the random content system assigns a random geographic location in the random content pool for each new piece of content.

7. The system of claim 3, wherein the random content system performs one or more content filtering checks to exclude a piece of random content from the selected one or more pieces of random content.

8. The system of claim 7, wherein the random content system blocks a piece of random content for the mobile device when the author of the piece of random content is blocked by the mobile device.

9. The system of claim 1, wherein the random content system cleans up expired one or more pieces of random content in the random content pool.

10. The system of claim 9, wherein the random content system determines an expiration date for each piece of random content in the random content pool and removes a piece of random content when the expiration date of the piece of content is exceeded.

11. The system of claim 1, wherein the random content system receives a new piece of content from a mobile device.

12. The system of claim 11, wherein the random content system captures one or an image and a video with the mobile device.

13. The system of claim 11, wherein the random content system generates a random geographic point for the new piece of content, wherein the random geographic point is a random location in the random content pool.

14. The system of claim 1, wherein the mobile device displays a piece of random content on the mobile device, the piece of random content not being displayed until the piece of random content is opened to be displayed on the mobile device.

15. A method, comprising:
receiving a request for random content; and
providing, to a mobile device, a random selection of content from a random content pool in response to the request for random content wherein the random selection of the content is limited by a content filter that does not permit the mobile device to receive a piece of random content already displayed on the mobile device.

16. The method of claim 15, wherein providing the random selection of content further comprises selecting a promoted piece of random content to select a special piece of content.

17. The method of claim 15, wherein providing the random selection of content further comprises selecting one or more pieces of random content from the random content pool.

18. The method of claim 17, wherein selecting one or more pieces of random content from the random content pool further comprises selecting the one or more pieces of random content based on a weighting of each piece of random content.

19. The method of claim 17, wherein selecting one or more pieces of random content from the random content pool further comprises determining a random location in the random content pool and selecting one or more pieces of random content within a proximity of the random location.

20. The method of claim 19, wherein selecting one or more pieces of random content from the random content pool further comprises assigning a random geographic location in the random content pool for each new piece of content.

21. The method of claim 17, wherein selecting one or more pieces of random content from the random content pool further comprises performing one or more content filtering checks to exclude a piece of random content from the selected one or more pieces of random content.

22. The method of claim 21, wherein performing one or more content filtering checks further comprises blocking a piece of random content for the mobile device when the author of the piece of random content is blocked by the mobile device.

23. The method of claim 15 further comprising cleaning up expired one or more pieces of random content in the random content pool.

24. The method of claim 23, wherein cleaning up expired one or more pieces of random content in the random content pool further comprises determining an expiration date for each piece of random content in the random content pool and removing a piece of random content when the expiration date of the piece of content is exceeded.

25. The method of claim 15 further comprising receiving a new piece of content from a mobile device.

26. The method of claim 25, wherein receiving the new piece of content further comprises capturing one or an image and a video with the mobile device.

27. The method of claim 25, wherein receiving the new piece of content further comprises generating a random geographic point for the new piece of content, wherein the random geographic point is a random location in the random content pool.

28. The method of claim 15 further comprising displaying a piece of random content on the mobile device, the piece of random content not being displayed until the piece of random content is opened to be displayed on the mobile device.
